(19) United States
(12) Patent Application Publication
(10) Pub. No.: US 2025/0119048 A1
(43) Pub. Date: Apr. 10, 2025

(54) ELECTRIC POWER GENERATOR

(71) Applicant: BLOWIN' IN THE WIND, S.L., Sevilla (ES)

(72) Inventors: Antoinio GUTIÉRREZ GÓMEZ, Sevilla (ES); Antonio GUTIÉRREZ GÓMEZ

(21) Appl. No.: 18/836,538

(22) PCT Filed: Jan. 30, 2023
(86) PCT No.: PCT/EP2023/052150

§ 371 Date: Aug. 7, 2024

(30) Foreign Application Priority Data
Feb. 21, 2022 (EP) 22382146.3

(51) Int. Cl. H02K 55/04

(52) U.S. Cl. CPC H02K 55/04

(57) ABSTRACT

This invention relates to an electric generator with an inductor assembly comprising: a rounded base arranged in a plane perpendicular to the rotation shaft and rotating about said shaft; a superconducting inductor coil covering the base, a stationary housing enclosure comprising a superconducting inductor coil and the base; a first cryogenic circuit housed in the base and thermally connected with the at least one superconducting inductor coil for cooling it, and a compressor connected to the first cryogenic circuit. The generator also comprises an induced assembly with two induced coils, covering means, a yoke, and thermal insulating means. Advantageously, the electric generator comprises a first vacuum atmosphere and the inductor coil comprises a plurality of layers of high-temperature superconducting material arranged in the base. The invention also relates to a drive system comprising said electric generator.

### TECHNICAL FIELD OF THE INVENTION

The present invention relates to an electric power generator. In particular, said device comprises an inductor assembly adapted to rotate together with a rotation shaft and an induced assembly. The invention also relates to any drive system comprising an electric power generator thereof.

Furthermore, the present invention relates to the technical field of electric generators comprising an inductor and one or more armatures.

### BACKGROUND OF THE INVENTION

In the field of electric generators, there is a known principle whereby a rotor that rotates with respect to a stator and, due to the interaction of the magnetic field generated by the rotor, whether it is one with electromagnets, permanent magnets, or any other which generates a magnetic field, causes, upon rotating with respect to the stator, an inductive current in the stator, an electric current being generated and therefore transforming the mechanical energy rotating the inductor into electric energy. This principle is applied to electricity generators, regardless of the origin of the energy causing the rotation of the rotor, where it can be wind energy, hydraulic energy, combustion energy, etc.

Technical breakthroughs in the field of generators have been accompanied by breakthroughs in rotating machines in general, where they are considered generators if they produce electricity and motors if they use electricity to generate rotary movement, and the final aim of the research and development concerning both is to reduce the torque generated by the machine against the movement of the rotor caused primarily by the effect of Lenz's law and the mechanical work of movement.

Breakthroughs have been considerable with the first introduction of permanent magnets to replace electromagnets, and subsequently with the introduction of superconductors to replace permanent magnets.

The introduction of superconductors in rotary machines has led to the need for the use of cryogenics to be able to obtain the specific characteristics provided by superconductors, both due to the so-called Meissner-Ochsenfeld effect, which consists of the complete disappearance of flux in the magnetic field within a superconducting material below its critical temperature, and due to the intrinsic capacity that superconducting materials hold to conduct electric current without resistance or energy loss in certain temperature conditions.

In a conventional ordinary rotating machine, an iron core is indispensable for achieving a high magnetic field intensity. The maximum magnetic flux density value is determined by the saturation magnetic flux density of iron and is about 2T. On the other hand, in the case of a superconductor, given that electrical resistance is set to zero and the current density may be high, the high magnetic field intensity may also be generated without an iron core. Therefore, weight can be reduced by that amount, and the magnetic field intensity is not restricted by the saturation magnetic flux density of iron, such that the output density can be even further increased.

A general configuration of a superconducting rotating machine is a synchronous machine having a field magnet that generates a direct current magnetic field and a stator which takes in and outputs an alternating current (AC). When an AC current is applied to a superconductor, the generation of heat due to the loss of AC becomes an issue; therefore, in most cases superconductors are used only in the inductor, for which it uses direct current, and the armature is made of a conventional conductor, usually copper. However, if a superconductor can be applied to the armature, the current density can be increased, such that greater efficiency may be achieved.

In recent years, with the development of technology to reduce alternating current loss in superconducting cables, the development of all superconducting rotary machines in which both the field magnet and the armature are superconductors is progressing. As for the positional relationship between the field magnet and the frame, although the radial type in which both are arranged in the radial direction is the most used type, the axial type in which both elements are arranged in the axial direction is also being used.

In the state of the art, there are two types of rotary machines: a first type with a rotating inductor and a second type with a rotating armature. Several known patent literature references regarding electric generators are mentioned below.

European patent application EP 2541742A2 describes a design in which the cryostat and the stator are kept stationary, rotating the rotor with the coils.

US patent application US2009/0229291 describes a superconducting rotor in which the superconducting coils are housed in a rotating hollow annular vacuum vessel.

Spanish patent ES2523975T3 describes a direct-action electric generator with superconducting coils for a horizontal-axis stationary wind turbine with a “hot rotor” cooled by contact.

U.S. Pat. No. 7,233,079B1 likewise describes a wind turbine generator with a rotor, stator, and superconducting magnetically-levitated bearings housed in an isolated vacuum enclosure.

Moreover, Japanese patent application JP2020080628A describes a radial rotary machine using superconductors both in the inductor and in the armature.

These last two documents, U.S. Pat. No. 7,233,079 and JP2020080628A, use a vacuum vessel as a thermal insulation.

Document U.S. Pat. No. 10,064,119 B2 discloses an electromagnetic device. The motors/generators of the preferred embodiments of U.S. Pat. No. 10,064,119 B2 include a rotating part (rotor) and a stationary part (stator). In the devices disclosed in this document, the primary function of the stator is to provide a high strength background magnetic field in which the rotor rotates. The rotor can be powered with a current that changes direction in concert with the relative change in magnetic field direction of the background field (that is, as the rotor moves from one magnetic pole to the next) in the case of a motor. In the case of a generator, the movement of the rotor generally results in the generation of an alternating voltage and current.

Finally, the non-patent literature comprises a paper by Colle et al. (“Analytical Model for the Magnetic Field Distribution in a Flux Modulation Superconducting Machine”, IEEE Transactions on Magnetics, 55(12), 1-9). Said paper mentions a vacuum as an insulating element.

Nevertheless, it can be seen in the state of the art that the performance of electric generators is in need of improvement, reducing rubbing and friction therein, more particularly in the rotor. A rotary machine having an even lower torque must also be obtained.

### BRIEF DESCRIPTION OF THE INVENTION

The present invention proposes a solution to the above problems by means of an electric generator according to claim 1 and a drive system according to claim 16. The dependent claims define preferred embodiments of the invention.

A first aspect of the present invention provides an electric generator comprising a rotation shaft adapted to rotate, and a stationary housing enclosure; the stationary housing enclosure in turn comprising:
a) an inductor assembly, adapted to rotate together with the rotation shaft, comprising:
   a rounded base arranged in a plane perpendicular to the rotation shaft;
   at least one superconducting inductor coil, arranged covering the rounded base, wherein the stationary housing enclosure is adapted to allow rotation of the rounded base therein together with the rotation shaft;
   a first cryogenic circuit thermally connected with the at least one superconducting inductor coil and said first cryogenic circuit being adapted to cool the at least one superconducting inductor coil;
   a compressor connected to the first cryogenic circuit, the compressor being adapted to feed the first cryogenic circuit; and
b) an induced assembly which comprises:
   at least one induced coil;
   covering means covering the at least one induced coil;
   a yoke covering the covering means;
   thermal insulating means covering the yoke; and
   wherein the induced assembly is connected to a current output;
wherein:
   the stationary housing enclosure comprises a first vacuum atmosphere generated by means of a vacuum circuit, where said vacuum circuit is connected to a vacuum pump;
   the at least one inductor coil comprises a plurality of layers of high-temperature superconducting material arranged in the rounded base; and
   the first cryogenic circuit is housed in the rounded base, in thermal contact with the at least one superconducting inductor coil;
      and wherein the first vacuum atmosphere of the stationary housing enclosure is one of the following atmospheres: a low-vacuum, i.e. in the pressure range of 1 to 300 mbar, and with a molecule density of between 10¹⁶ and 10¹⁹ molecules/cm³; medium-vacuum, i.e. in the pressure range of 10⁻³ to 1 mbar, and with a molecule density of between 10¹³ and 10¹⁶ molecules/cm³ or high vacuum, i.e., in the pressure range of 10⁻⁷ to 10⁻³ mbar, and with a molecule density of between 10⁹ and 10¹³ molecules/cm³; and wherein the thermal insulating means comprise a second vacuum atmosphere, the second vacuum atmosphere of the thermal insulating means being one of the following atmospheres: a high-vacuum; or ultrahigh-vacuum, i.e. in the pressure range of 10⁻¹² to 10⁻⁷ mbar, and with a molecule density of between 10⁴ and 10⁹ molecules/cm³; and wherein the second vacuum atmosphere is enclosed between two walls of the stationary housing enclosure.

Throughout the present document, “rounded base” will be understood to mean a substantially planar support structure having a rounded contour, without sharp edges, suitable for rotating about a rotation shaft. Examples of “rounded bases” comprise, in a non-limiting manner, a circular disk, an ellipse, a ring, an annulus, etc.

Likewise, in the context of the present invention, a “first cryogenic circuit” or a “second cryogenic circuit” (which will be introduced below) refers to any cryostat or cryogenic system which allows cooling the coils of the electric generator, for example, to temperatures around 260° C. below zero. These cryogenic temperatures are achieved as a result of these cryogenic circuits preferably comprising a dewar and the cryogenic refrigerator. The elements to be cooled, in this case the superconducting inductor coils or the induced coils, are introduced in a vessel in which the vacuum is generated (dewar), such that convection is eliminated, and conduction is minimized.

All dewars have two or more walls, with a high vacuum maintained between said walls.

This provides very good thermal insulation between the interior and exterior of the dewar, which reduces the rate of vacuum leakage.

Two elements are understood to be “thermally connected” when said elements are arranged to allow heat transfer between both. For example, two elements in direct contact allow heat transfer by conduction. In contrast, throughout the present description, and if no specific indication is made in that regard, the term “connection” or “feed” refers to an electrical connection.

Additionally, throughout the present document “rotor” or “inductor assembly” will be understood to mean the assembly of the base and of the at least one inductor coil which are housed in the stationary housing enclosure, suitable for rotation within said stationary housing enclosure together with the rotation shaft.

Advantageously, the use of a “rounded base” allows for greater motor efficiency. In particular, a disc-shaped or annulus-shaped base allows for greater motor efficiency.

The induced assembly is connected to an output for the current generated by magnetic induction of the inductor assembly.

In the invention, the rounded base of the inductor assembly rotates “together with” the rotation shaft, that is to say, both elements rotate jointly, as a whole.

The “stationary housing enclosure” would be understood as a housing enclosure which comprises the inductor assembly and the induced assembly. In certain embodiments, said stationary housing enclosure is attached to the rotation shaft (e.g., by means of a magnetic seal) such that the rotation of the rotation shaft and the rounded base is allowed, while the stationary housing enclosure remains static. Note that, although the rounded base is allowed to rotate within the stationary housing enclosure, said enclosure remains static. In this way, the arrangement of two walls of the stationary housing enclosure along with the second vacuum atmosphere work as a dewar, in a sandwich configuration, such that the second vacuum atmosphere is enclosed or surrounded by the walls.

The superconducting inductor coils can be arranged in the rounded base by means of ceramic deposition using inkjet-based printing techniques. These techniques are advantageous because they confer flexibility and control of the deposition, together with the possibility of scaling up this technique.

For example, in one embodiment of the invention when the rounded base is a disc, said disc is encapsulated in an annular-shaped or hollow cylinder-shaped stationary housing enclosure in which the vacuum is generated.

The vacuum in the vacuum circuit is generated by means of mechanical equipment, preferably a compressor, designed to draw air out from inside the stationary housing enclosure as a result of the vacuum pump.

In preferred embodiments, the electric generator comprises a current source and the at least one superconducting inductor coil is connected to at least a current source.

In preferred embodiments, the compressor of the vacuum pump is external equipment that can be connected to generate the vacuum and disconnected when the electric generator starts up.

The stationary housing enclosure is not strictly leak-tight since it is attached, through a mobile attachment, to the rotation shaft. Said attachment is performed by means of a magnetic fluid seal which allows sealing a relatively low pressure (about 0.2 bar), a larger number of seals being placed in cascade when a higher pressure difference is to be sealed. The magnetic seals are particularly suitable for rotating applications and do not require contact, which contributes to preventing wear of the electric generator. In this way, both the mobile attachment and the rotation shaft are adapted to move, whereas the stationary housing enclosure is static. Indeed, the mobile attachment allows the rotation of the inductor assembly within the stationary housing enclosure, such that the inductor assembly (in particular, its rounded base) and the rotation shaft rotate jointly, as a whole, during the operation of the generator, while the stationary housing enclosure remains static.

When the rotor is introduced in a vacuum atmosphere, the problem of cooling the layers of superconducting material arranged at the base is generated, which problem does not occur in other known electric generators. This problem has been solved by arranging the first cryogenic circuit inside the rotor, which allows improving generator performance as a result of less rubbing in the rotor.

The metal yoke is preferably made of steel and allows providing a low-reluctance path for the magnetic flux.

If there are multiple inductor coils, said inductor coils are connected to one another by means of connections made of a superconducting material, for example, the same high-temperature superconducting material used for forming said inductor coils. The induced coils are likewise connected to one another, preferably by means of connections made of a superconducting material, like the inductor coils. Therefore, the induced coils can be implemented in the same way as the superconducting inductor coil, by means of layers of high-temperature superconducting material.

To operate the electric generator of the invention, the inductor assembly comprises a connection to an input (current source) such that when the electric current circulates through the at least one superconducting inductor coil, magnetic energy is generated, which magnetic energy in turn generates electric current in the induced assembly acting as an armature. Additionally, the electric generator of the invention comprises a final current output connected to two of the induced coils (if there are more than two), for storing in or feeding to any other device or battery. The electric energy generated with the generator is thereby drawn out. Nevertheless, the number of input current sources into the generator and the number of final current outputs may vary, depending on the application for which the generator is to be used, as well as the power required.

In a particular embodiment of the electric generator of the invention, hereinafter referred to as “embodiment A”, the covering means of the electric generator comprise frames covering the at least one induced coil.

The frame additionally comprises one or more switches connected to the at least one induced coil and is configured for controlling the connections to said induced coil, where different logic circuits may be defined within the frame.

That is advantageous should the generator be required to have several current outputs to feed various devices simultaneously and independently.

In another particular embodiment of the electric generator of the invention, hereinafter referred to as “embodiment B”, being an alternative to “embodiment A”:
the at least one induced coil of the induced assembly is a superconducting induced coil and comprises a plurality of layers of high-temperature superconducting material; and
the covering means comprise a second cryogenic circuit adapted to cool the at least one induced coil.

Advantageously, in this particular embodiment the induced coils of the electric generator also comprise superconducting material (for example, the same superconducting material of the at least one superconducting inductor coil) and are connected to others with said superconducting material, which confers greater efficiency to the generator. The layers of superconducting material of the induced coils can also be arranged by means of inkjet techniques.

In this embodiment, the second cryogenic circuit can be implemented in a manner similar to the first cryogenic circuit, although it can also have a different structure, such as for example, using a different cryogenic gas, different pressures and vacuum conditions, etc.

In another particular embodiment, the covering means comprise at least one one-way magnetic filter, i.e., a filter adapted to allow the passage of magnetism in a single direction, resisting against the passage of said magnetism in the opposite direction.

Advantageously, the one-way magnetic filter solely allows the passage of magnetism in a single direction, thus restraining the passage of magnetism in the opposite direction.

In a preferred embodiment, the one-way filter comprises a permeable face in contact with the induced assembly of the electric generator and an impermeable face; wherein the permeable face is manufactured with a topological insulating material and the impermeable face is manufactured with a nickel and cobalt alloy.

In an even more preferred embodiment, the topological insulating material comprise bismuth and/or tellurium.

In this embodiment, the one-way filter comprises, on one hand, a face having polyhedral truncated pyramids or cones due to the intersection with the plane of a first face, referred to as “permeable face” (in contact with the stator of the electric generator) and a second face referred to as “impermeable face”. The impermeable face has a planar shape and is stamped with the sharp edge of the truncated pyramids or cones of the permeable face, such that empty interstitial spaces are formed between both faces. The attachment between said pyramids is defined by sharp edges of the truncated pyramids or cones. The first face (permeable face) is manufactured with a topological insulating material, for example bismuth and tellurium. Since it is a topological insulator, it does not allow the passage of electric current through its volume, but it does allow passage through its surface, such that the magnetic current does not sustain any loss of energy when circulating on the surface. Magnetic waves reflected on the inner surface of the first pyramid are thereby transported and concentrated in the truncated portion and transmitted to the second face of the insulating barrier in their entirety through the free space of the truncation. The second face, which is opposite the first face, creates a shielding with respect to the magnetic force generated in the stator. For example, the second face is manufactured with a nickel and cobalt alloy, thus reducing the magnetic permeability thereof. In the filter, this structure of truncated pyramids is replicated for completely shielding or covering the induced assembly (stator). In even more preferred embodiments, the topological insulating material of the filter is determined by the chemical formula MnBi₂Te₄. Nevertheless, the materials mentioned for this filter are illustrative, and others having similar magnetic properties may be used.

In another particular embodiment of the electric generator of the invention, the inductor assembly of the electric generator also comprises a first bearing for the base, where the first bearing is adapted to rotate the base about the rotation shaft.

More preferably, the first bearing is configured for rotating the base about the rotation shaft. In some embodiments, the first bearing is a conventional or a magnetic bearing.

Advantageously, in some embodiments the traction forcing the rotation of the rotor is provided by means of magnetic elements. Furthermore, magnetic bearings allow very low-friction and mechanical wear-free movements. Nevertheless, they also impede the implementation of the generator, so the use of conventional bearings as first bearings (e.g. ball bearings, tapered roller bearings, etc.), are also suitable in certain embodiments of the electric generator, although they do sustain gradual wear.

In an exemplary embodiment, a low vacuum, preferably in the pressure range of 1-300 mbar, is applied for the first vacuum atmosphere, which allows achieving the intended objective of reducing rubbing of the rotor and, at the same time, allows a simple magnetic fluid sealing.

In other alternative embodiments, the first vacuum atmosphere is a medium-vacuum or high-vacuum atmosphere, which improves the performance of the electric generator of the invention by even further reducing rubbing. Nevertheless, the use of a medium or high vacuum would necessitate the implementation of more efficient sealing and would require the application of a plurality of seals in cascade to obtain the vacuum in the first vacuum atmosphere. Therefore, the use of a medium or high vacuum increases the number of seals needed for the operation of the electric generator of the invention and make it more expensive to manufacture.

Throughout this document, the following definitions shall be understood with respect to the vacuum atmospheres, for pressures below atmospheric pressure:
“Low vacuum”: In the pressure range of 1 to 300 mbar, and with a molecule density of between 10¹⁶ and 10¹⁹ molecules/cm³.
“Medium vacuum”: In the pressure range of 10⁻³ to 1 mbar, and with a molecule density of between 10¹³ and 10¹⁶ molecules/cm³.
“High vacuum”: In the pressure range of 10⁻⁷ to 10⁻³ mbar, and with a molecule density of between 10⁹ and 10¹³ molecules/cm³.
“Ultrahigh vacuum”: In the pressure range of 10⁻¹² to 10⁻⁷ mbar, and with a molecule density of between 10⁴ and 10⁹ molecules/cm³.

Advantageously, the first vacuum atmosphere favors reducing rubbing and, therefore, greater motor efficiency.

In another particular embodiment of the electric generator of the invention, the compressor is adapted to feed the first cryogenic circuit through a rotary valve.

Said rotary valve is preferably located inside the rotation shaft. The first cryogenic circuit is thereby a compression and decompression circuit, with recirculation, in contact with the layers of superconducting material and moved by a compressor.

In another particular embodiment of the electric generator of the invention, the first cryogenic circuit comprises a closed circuit connected to a McMahon compressor.

In this compressor, a fluid (for example, cryogenic gas, as will be seen below) has an initial temperature and is compressed. As a result of that compression, the generated heat is drawn out by means of air-cooled heat exchangers. The fluid is then expanded to produce cold below the initial temperature.

In another particular embodiment of the electric generator of the invention, the first cryogenic circuit comprises a low-density cryogenic gas.

In another even more preferred embodiment of the electric generator of the invention, the cryogenic gas of the first cryogenic circuit is liquid nitrogen, helium, or a combination of both.

Throughout the present document, “low-density cryogenic gas” will be understood to mean cryogenic gases having a density less than the density of air.

Advantageously, nitrogen is converted to the liquid state at a temperature equal to or less than its boiling temperature, which is −195.8° C. (77.35 K), at a pressure of one atmosphere, while helium requires a considerably lower temperature (at least −268.9° C. or 4.25 K) to transition to the liquid state at said pressure. Therefore, the use of nitrogen facilitates implementation of the first cryogenic circuit since it does not require lowering the temperature in such an excessive manner and is more cost-effective.

It should be pointed out that in the embodiments of an electric generator comprising a second cryogenic circuit, said second cryogenic circuit can be implemented using a low-density cryogenic gas and by means of a closed circuit connected to a McMahon compressor, just like the first cryogenic circuit.

Therefore, by using a closed first cryogenic circuit, connected by means of a rotary valve to a McMahon compressor in which a low-density cryogenic gas under a certain pressure circulates, transmission is achieved, by direct thermal connection, in particular by contact by means of conduction, between the first cryogenic circuit and the layers of superconducting material of the at least one inductor coil. Furthermore, it is performed at an optimal temperature for the operation of the at least one inductor coil of the generator.

The second vacuum atmosphere is leak-tight (does not require magnetic fluid sealing) and can be implemented, for example, as a dewar vessel. The use of an ultrahigh vacuum in this second vacuum atmosphere provides better performances.

In some embodiments of the invention, said second atmosphere can be generated by means of the same vacuum circuit and the same vacuum pump with which the first vacuum atmosphere is obtained; or else a second vacuum circuit can be arranged together with a second vacuum pump for this purpose.

In another particular embodiment of the electric generator of the invention, the high-temperature superconducting material (HTS material) of the at least one superconducting inductor coil and/or the at least one induced coil comprises at least one of the following materials: an yttrium barium copper oxide compound, abbreviated as YBCO (YBa₂Cu₃O_{7-δ}) or La_{1.85}Ba_{0.15}CuO₄.

Throughout this document, HTS material will be understood to mean those materials with a critical temperature greater than the boiling temperature of nitrogen (about 77.35 K).

Advantageously, YBCO exhibits superconducting properties at the temperature of liquid nitrogen. In general, these HTS materials allow producing ultrathin electricity-conducting wiring minimizing resistance and without losses due to overheating.

In another particular embodiment of the electric generator of the invention, the rounded base comprises PTFE (polytetrafluoroethylene, better known as Teflon) or fluorinated ethylene propylene (FEP).

Advantageously, these materials used in the rounded base, as well as in other structural elements of the generator, remain stable at very low temperatures. For example, FEP is cryogenically stable at temperatures less than −195° C. (78.15 K).

In another particular embodiment of the electric generator of the invention, at least the layers of superconducting material of the inductor coils or the induced coils are arranged by means of a ceramic deposition using an inkjet technique.

As the most relevant advantages of the generator of the invention compared to other known alternatives in the state of the art, the following stand out:
Reduction of torque of the inductor assembly as a result of the incorporation of a first vacuum atmosphere in the space in which said inductor assembly freely rotates, which minimizes rubbing and friction. This first vacuum atmosphere complementarily provides thermal insulation to the inductor assembly. In contrast, in the state of the art vacuum is used exclusively for thermally insulating the entire generator, which is only equivalent to the second vacuum atmosphere of the present invention.
More power generated.
Lower weight of the generator because printing the layers of superconducting material on the base allows reducing inductor weight.
Higher magnetic field intensity, also as a result of the use of layers of superconducting material. As a result of the layers of superconductor, magnetic fields may surpass 2T, which is typically the limit in a conventional electric generator.

In a preferred embodiment of the electric generator, the stationary housing enclosure and the rotation shaft are attached by means of at least one magnetic seal.

A second aspect of the present invention provides a drive system comprising an electric generator as described above.

In reference to this invention, “drive system” shall be defined as any system which actuates the rotor of the electric generator of the invention to produce energy. A wind-powered generator or a vehicle are considered examples of a drive system, although these elements are non-limiting. For example, in the case of a wind-powered generator in a wind turbine, said energy would be determined by the transformation of kinetic energy of the wind into mechanical energy. In the case of a moving vehicle, said energy would be determined by the kinetic energy of the wind as said vehicle travels. Another example of a drive system for which it would be suitable to use the present invention would be any mechanical system, electrical system, and/or electromechanical system actuating the rotor of a motor (both an electric motor and a combustion engine).

Advantageously, the generator of the invention is suitable for being applied in drive systems like vehicles (e.g., the generator can work as an electric vehicle drivetrain).

By way of summary, an essential and differential feature of the electric generator of the present invention, compared with other known generators, is that this generator has a double vacuum atmosphere (by way of vacuum capsules or vessels): a first atmosphere (for example, a low-vacuum or medium-vacuum atmosphere) in which the rotor rotates, and a second atmosphere (for example, a high-vacuum or ultrahigh-vacuum atmosphere) encompassing the former and serving as a thermal insulation. Another one of the fundamental features of this invention is the design of the inductor assembly, in the form of a multilaminar disc, perpendicular to the rotation shaft in which the superconducting inductor coils are arranged (for example, by means of ceramic deposition using the inkjet technique), the first cryogenic circuit being positioned therein connected by means of a rotary valve to a compressor (for example, a McMahon compressor).

All the features described in this specification (including the claims, description, and drawings) can be combined in any combination, with the exception of the combinations of such mutually exclusive features.

### DESCRIPTION OF THE DRAWINGS

These and other features and advantages of the invention will become more apparent from the following detailed description of a preferred embodiment, given solely by way of illustrative and non-limiting example, in reference to the attached figures.

FIG. 1 shows an embodiment of the electric generator according to the invention.

FIG. 2 shows a three-quarter view of the inside of an embodiment of the electric generator according to the invention.

FIG. 3 shows a section of the three-quarter view of the inside of the same embodiment of the electric generator according to the invention.

FIG. 4 shows a profile view of the section of the inside of the same embodiment of the electric generator according to the invention.

FIG. 5 shows a detailed profile view of the same embodiment.

FIG. 6 shows a planar view of a depiction of the at least one superconducting inductor coil according to the invention.

FIG. 7 shows a profile view of the section of the inside of another embodiment of the electric generator according to the invention.

### DETAILED DESCRIPTION OF THE INVENTION

FIGS. 1 to 7, which illustrate non-limiting preferred embodiments of the scope of the present invention, are described below. The exemplary embodiments of the invention described below are suitable for axial rotors, with this description not being limiting of same because the invention is applicable to radial rotors by simply changing the distribution of the elements of the electric generator.

FIG. 1 shows an embodiment of an electric generator (100) comprising an outer casing (104), an air inlet (105), and an air outlet (106). In a particular example, the air inlet (105) has a larger area than the air outlet (106).

The outer casing (104) of the electric generator (100) is preferably made of a resistant material. This embodiment is adapted to the use thereof in a moving vehicle, and the shape of the air inlet (105) is adapted for air to enter in a direction perpendicular to the rotation shaft (not depicted in FIG. 1).

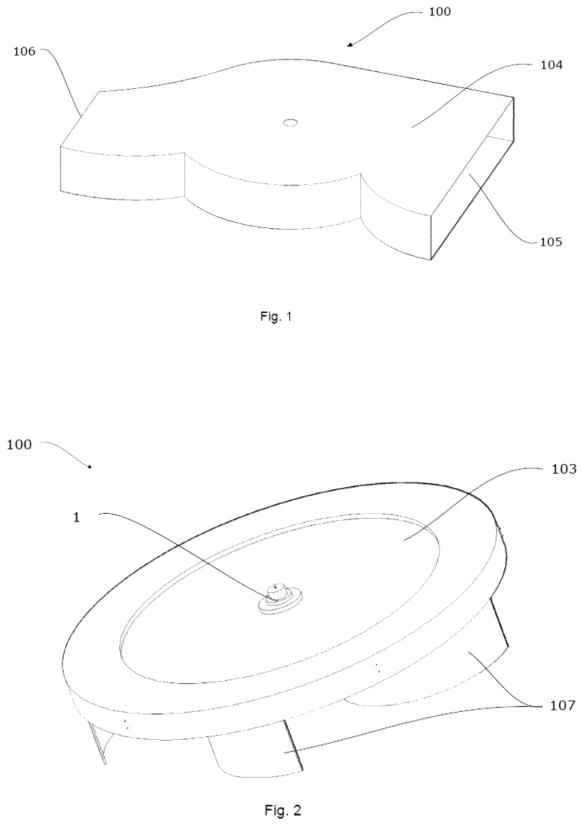

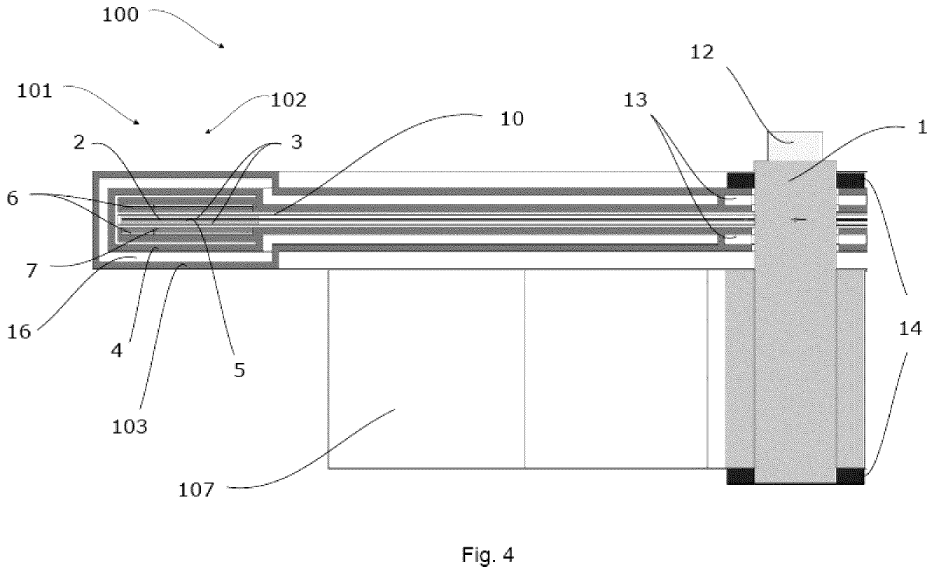

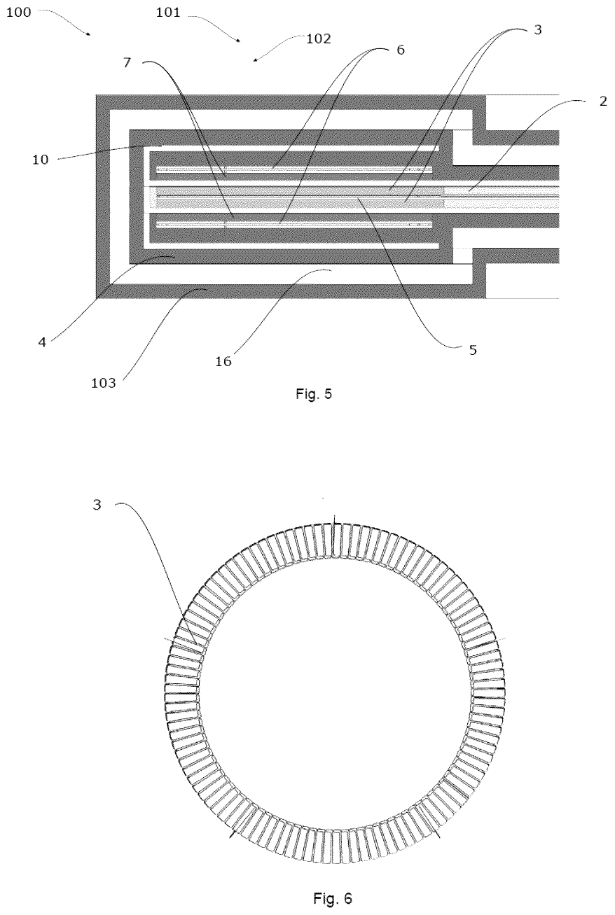

FIG. 2 shows a view of an embodiment of the electric generator (100) according to the invention, which comprises an induced assembly (not depicted in FIG. 2) and an inductor assembly (not depicted in FIG. 2) which are housed within the stationary housing enclosure (4, 103). The stationary housing enclosure (4, 103) remains static, while a rotation shaft (1) rotates during the operation of the electric generator (100). The stationary housing enclosure (4, 103) comprises two walls: a first wall (4) and a second wall (103) enclosing a second vacuum atmosphere (16), in a sandwich configuration. In this way, the arrangement of the stationary housing enclosure (4, 103) along with the second vacuum atmosphere (16) work as a dewar. This sandwich configuration is better illustrated in FIGS. 4 and 5. In the particular embodiment of FIG. 2, said rotation shaft (1) is attached to a plurality of blades (107). The plurality of blades (107) thereby transform the kinetic energy of the wind into mechanical energy and, in this embodiment, take in the wind perpendicular to the rotation shaft (1).

Preferably, the plurality of blades (107) are arranged on a plane perpendicular to the rotation shaft (1) and, therefore, perpendicular to the direction in which air enters the electric generator (100).

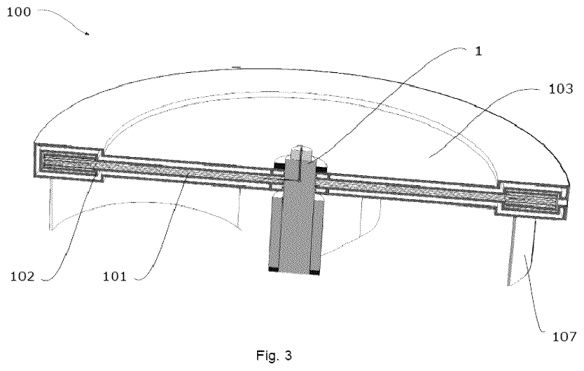

FIG. 3 depicts a cross-section view of the preceding embodiment of the electric generator (100) which shows the location of the inductor assembly (101) and the induced assembly (102), both housed within the stationary housing enclosure (4, 103).

The next FIGS. 4 and 5 describe and show in greater detail the various elements comprised in the electric generator (100).

In a particular example, the inductor assembly (101) and the induced assembly (102) have the same shape, preferably circular.

FIG. 4 is a side view of the cross-section view of the preceding embodiment of the electric generator (100) in which the arrangement of the different elements from the rotation shaft (1) to an end of the radius of the induced assembly (102) can be seen. Due to symmetry with respect to the rotation shaft (1), the same arrangement of the elements from the rotation shaft (1) to the right is understood to reproduce the arrangement of the elements from the rotation shaft (1) to the left as depicted in FIG. 4.

In the particular embodiment of FIG. 4, the rotation shaft (1) is shown attached to the plurality of blades (107) in the lower part thereof. Furthermore, said rotation shaft (1) has a rotary valve (12) in its upper part which is adapted to connect a compressor (not depicted), which allows feeding the first cryogenic circuit (5).

The inductor assembly (101) of the electric generator (100) is adapted to rotate jointly with the rotation shaft (1). Said rotation shaft (1) is also connected with two second bearings (14), preferably above and below the same rotation shaft (1), in order that the rotation shaft (1) rotates with the plurality of blades (107).

Preferably, the second bearings (14) are either conventional or else magnetic bearings (e.g., in some embodiments, similar to the first bearings (11)) to allow very low-friction and mechanical wear-free movements.

In the present embodiment of FIG. 4, that is, the same embodiment as in FIGS. 3 and 5, the inductor assembly (101) comprises a rounded base (2), two superconducting inductor coils (3) which are arranged covering the rounded base (2), a stationary housing enclosure (4, 103) which comprises the rounded base (2) and the two superconducting inductor coils (3), a first cryogenic circuit (5) thermally connected with the two superconducting inductor coils (3), and a compressor (not depicted) connected to the first cryogenic circuit (5) adapted to feed said first cryogenic circuit (5) through the rotary valve (12).

In particular, the first cryogenic circuit (5) is housed in the rounded base (2) and is in thermal contact with the at least one superconducting inductor coil (3).

Also, in particular, the stationary housing enclosure (4, 103) is adapted to allow rotation of the rounded base (2) therein together with the rotation shaft (1). The same stationary housing enclosure (4, 103) comprises a first vacuum atmosphere by means of a vacuum circuit (10) connected to a vacuum pump (not depicted).

Furthermore, the two superconducting inductor coils (3) of the electric generator (100) comprise a plurality of layers of high-temperature superconducting material which are arranged in the rounded base (2).

Preferably, the rounded base (2) of the inductor assembly (101) comprises polytetrafluoroethylene and/or fluorinated ethylene propylene and preferably has a thickness of 0.24 mm.

Advantageously, since it is thermally connected with the two superconducting inductor coils (3), the first cryogenic circuit (5) allows cooling said superconducting inductor coils (3).

In some embodiments of the electric generator (100), the stationary housing enclosure (4, 103) is not strictly leak-tight given the mobile attachment between said stationary housing enclosure (4, 103) and the rotation shaft (1). Said attachment between both elements (the rotation shaft and the stationary housing enclosure) is performed by means of at least one magnetic seal (13), and the electric generator (100) can have a large number of magnetic seals (13) in cascade such that they allow sealing larger pressure differences if necessary.

Furthermore, the stationary housing enclosure (4, 103) of the particular embodiment of FIG. 4, that is, the same embodiment as FIGS. 3 and 5, houses therein the inductor assembly (101) and the induced assembly (102). Said induced assembly (102) comprises two induced coils (6) and covering means (7) covering the two induced coils (6).

In a particular example, the covering means (7) are at least one one-way magnetic filter.

Preferably, the first cryogenic circuit (5) comprises a closed circuit and is connected to a McMahon compressor (not depicted in the figures).

Also preferably, the first cryogenic circuit (5) comprises a low-density cryogenic gas such as liquid nitrogen, helium, or a combination of both. More preferably, the low-density cryogenic gas is liquid nitrogen.

In other examples, the covering means (7) comprise a second cryogenic circuit adapted to cool the induced coils (6).

In another particular example of the electric generator (100), the induced coils (6) are superconducting coils and comprise a plurality of layers of high-temperature superconducting material.

In another particular example, the high-temperature superconducting material of the superconducting inductor coils (3) and/or the induced coils (6) comprise at least one of the following materials: YBCO or La_{1.85}Ba_{0.15}CuO₄.

Preferably, the superconducting inductor coils (3) comprise a plurality of layers of YBCO, with a total thickness of 100 μm, arranged in the rounded base (2).

Preferably, the induced coils (6) comprise a plurality of layers of YBCO, with a total thickness of 100 μm.

Furthermore, in the embodiment of the electric generator (100) of FIG. 4, there is formed between the first wall (4) of the stationary housing enclosure and the second wall (103) a second vacuum atmosphere (16). Preferably, the second vacuum atmosphere (16) is a high-vacuum or ultrahigh-vacuum atmosphere.

To facilitate viewing the arrangement of elements at the ends of the radii of the electric generator (100), an enlarged view of said area is provided in FIG. 5.

As shown in FIG. 5, the inductor assembly (101) has therein a hollow rounded base (2) in which the first cryogenic circuit (5) is located. Since it is located within the rounded base (2), the cryogenic circuit (5) is in direct thermal contact with the two superconducting inductor coils (3). Note also that the second vacuum atmosphere (16) is sandwiched between the first wall (4) and the second wall (103) of the stationary housing enclosure (4, 103), as in a dewar.

The rounded base (2) is separated from the covering means (7) by means of the vacuum circuit (10), which allows the wear-free rotation of the inductor assembly (101) about the rotation shaft (see FIGS. 3 and 4). Said rotation of the inductor assembly (101) is performed with respect to the induced assembly (102), which continues to be immobile any time the electric generator (100) is operating.

Furthermore, the stationary housing enclosure (4, 103) is connected with the covering means (7), which cover the two induced coils (6), each of the induced coils (6) being oriented facing each face of the rounded base (2). Therefore, in addition to the aforementioned transverse symmetry with respect to the rotation shaft, there is horizontal symmetry in the arrangement of elements at the end of the electric generator (100) with respect to the first cryogenic circuit (5).

The content of the detailed description of FIGS. 3 and 4 also applies to FIG. 5, with said FIG. 5 being an enlarged view of the end of the embodiment of the electric generator (100) of FIGS. 3 and 4.

FIG. 6 shows an embodiment of a superconducting inductor coil (3) which is arranged in and covers the rounded base (not depicted in that figure). In that particular embodiment, the superconducting inductor coil (3) is annulus-shaped to facilitate the arrangement thereof at the ends of the rounded base and such that said superconducting inductor coil (3) is oriented facing an induced coil (not depicted in that figure). Said superconducting inductor coil (3), and each superconducting inductor coil (3) comprised in the electric generator (100), is preferably implemented by means of layers of high-temperature superconducting material.

Additionally, the inductor assembly comprises a connection to a current source such that, as electric current circulates through the superconducting inductor coil(s) (3), magnetic energy is generated, which magnetic energy in turn generates electric current in the induced assembly (102, not depicted).

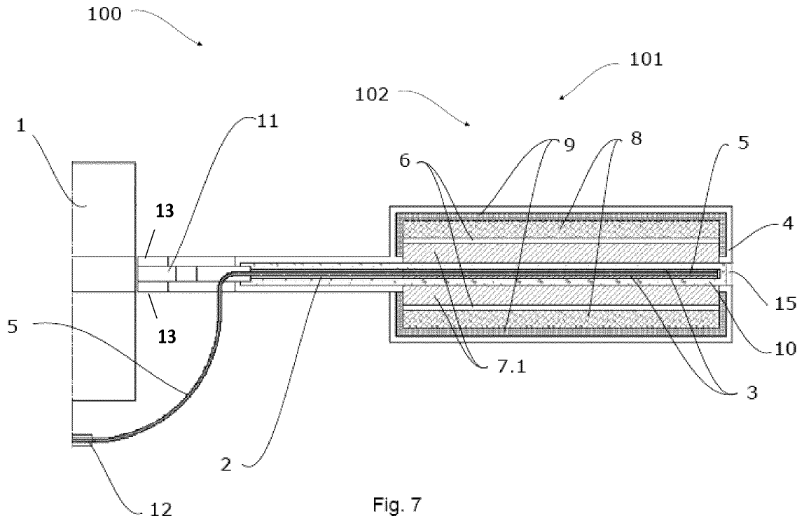

FIG. 7 shows a cross-section of another embodiment of the electric generator (100) of the invention. Said FIG. 7 depicts, as depicted in FIG. 4, a view of half of the embodiment of the electric generator (100) given that the rotation shaft (1) is also an axis of symmetry in that embodiment of the electric generator (100). Therefore, the arrangement of the elements provided in FIG. 7 is the same along the entire contour of the electric generator (100). In FIG. 7, the attachment between the rotation shaft and the stationary housing enclosure (4, 103) is performed by means of two magnetic seals (13), and the magnetic first bearing (11) does not move jointly with the rotation shaft (1). Note that the magnetic seals (13) also work as a bearing and, at the same time, prevent from vacuum leakage.

In that embodiment, the inductor assembly (101) is adapted to rotate about the rotation shaft (1) and comprises a rounded base (2), two superconducting inductor coils (3) which are arranged covering the rounded base (2), a stationary housing enclosure (4, 103) which comprises the rounded base (2) and the two superconducting inductor coils (3), a first cryogenic circuit (5) thermally connected with the two superconducting inductor coils (3), and a compressor (not depicted) connected by means of a rotary valve (12) to the first cryogenic circuit (5) adapted to feed said first cryogenic circuit (5).

In the embodiment of FIG. 7, the second wall (103) of the stationary housing enclosure (4, 103) that should be covering the rest of the elements to complete the electric generator (100) is not depicted.

In that same embodiment of FIG. 7, the first wall (4) of the stationary housing enclosure (4, 103) houses therein the inductor assembly (101) and the induced assembly (102) which comprises two induced coils (6) facing each face of the rounded base (2) covered with a superconducting inductor coil (3), covering means (7) covering the at least two induced coils (6), a yoke (8) covering the covering means (7), and thermal insulating means (9) covering the yoke (8).

The yoke (8) is preferably metallic and is preferably made of steel and allows providing a low-reluctance path for the magnetic flux. The yoke (8) preferably has a thickness of 48 mm.

Furthermore, the stationary housing enclosure (4, 103) is adapted to allow rotation of the rounded base (2) therein and together with the rotation shaft (1). The same stationary housing enclosure (4, 103; the second wall 103 is not depicted) comprises a second vacuum atmosphere (not depicted) by means of a vacuum circuit (10) connected to a vacuum pump (not depicted) through a valve (15).

In particular, the first cryogenic circuit (5) is housed in the rounded base (2) and is in thermal contact with the at least one superconducting inductor coil (3).

Also, in particular, the stationary housing enclosure (4, 103) is adapted to allow rotation of the rounded base (2) therein and together with the rotation shaft (1), that is to say, both elements rotate jointly, as a whole. Thus, both the rounded base (2) and the rotation shaft (1), are allowed to rotate while the stationary housing enclosure (4, 103) remains static.

Furthermore, the two superconducting inductor coils (3) of the electric generator (100) comprise a plurality of layers of high-temperature superconducting material which are arranged in the rounded base (2).

The rounded base (2) of the inductor assembly (101) preferably comprises polytetrafluoroethylene and/or fluorinated ethylene propylene and preferably has a thickness of 0.24 mm.

Advantageously, since it is thermally connected with the two superconducting inductor coils (3), the first cryogenic circuit (5) allows cooling said superconducting inductor coils (3).

In a particular example, the covering means (7) are at least one one-way magnetic filter.

Preferably, the first cryogenic circuit (5) comprises a closed circuit and is connected to a McMahon compressor (not depicted in the figures).

Also preferably, the first cryogenic circuit (5) comprises a low-density cryogenic gas such as liquid nitrogen, helium, or a combination of both. More preferably, the low-density cryogenic gas is liquid nitrogen.

In other examples, the covering means (7) comprise a second cryogenic circuit adapted to cool the induced coils (6).

In another particular example of the electric generator (100), the induced coils (6) are superconducting coils and comprise a plurality of layers of high-temperature superconducting material.

In another particular example, the high-temperature superconducting material of the superconducting inductor coils (3) and/or induced coils (6) comprise at least one of the following materials: YBCO or La_{1.85}Ba_{0.15}CuO₄.

Preferably, the superconducting inductor coils (3) comprise a plurality of layers of YBCO, with a total thickness of 100 μm, arranged in the rounded base (2).

Preferably, the induced coils (6) comprise a plurality of layers of YBCO, with a total thickness of 100 μm.

In the particular embodiment of FIG. 7, the covering means (7) comprise frames (7.1) which cover the induced coils (6). Additionally, in another particular embodiment, the covering means (7) comprise a second cryogenic circuit adapted to cool the induced coils (6).

In another example, the thermal insulating means (9) comprise a second vacuum atmosphere and said second vacuum atmosphere is a high-vacuum or ultrahigh-vacuum atmosphere.

Additionally, the frames (7.1) comprise one or more switches connected to the at least two induced coils (6) and are configured for controlling the connections to said induced coils (6), where various circuits can be defined within said frames (7.1).

In another particular example, the thermal insulating means (9) comprise the leak-tight second high-vacuum atmosphere and said second high-vacuum atmosphere has a thickness of 0.67 mm and is covered with a wall 0.48 mm thick. The inner part of the ultrahigh-vacuum chamber that is in contact with the inductor assembly (101) and induced assembly (102) can be made of the same material as the rounded base (2), for example polytetrafluoroethylene, whereas the outside of this ultrahigh-vacuum chamber can be made of steel or aluminum.

In a particular example, the vacuum of the second high-vacuum atmosphere is generated during a prior step of manufacturing, and once generated, it is sealed (for example, with a valve).

In each embodiment, the following definitions are understood with respect to vacuum atmospheres for pressures below atmospheric pressure:
“Low vacuum”: In the pressure range of 1 to 300 mbar, and with a molecule density of between 10¹⁶ and 10¹⁹ molecules/cm³.
“Medium vacuum”: In the pressure range of 10⁻³ to 1 mbar, and with a molecule density of between 10¹³ and 10¹⁶ molecules/cm³.
“High vacuum”: In the pressure range of 10⁻⁷ to 10⁻³ mbar, and with a molecule density of between 10⁹ and 10¹³ molecules/cm³.
“Ultrahigh vacuum”: In the pressure range of 10⁻¹² to 10⁻⁷ mbar, and with a molecule density of between 10⁴ and 10⁹ molecules/cm³.

The sizes and thicknesses of the elements of FIGS. 1-7 are not limiting and other embodiments of the invention could be sized differently depending on the application for which the electric generator (100) is to be used.

In a preferred embodiment of the invention, the invention works as an electricity generator by transforming an external mechanical force first into a magnetic force, and in turn transforming magnetic force into electrical force. Similarly, this embodiment could also be adapted to work inversely, acting like a motor, by applying electric energy to the induced assembly (102) and causing rotary mechanical output.

Additional embodiments (clauses) of the invention are disclosed below.

Clause 1. An Electric generator (100), the electric generator (100) comprising:
an inductor assembly (101), adapted to rotate about a rotation shaft (1), comprising:
   a rounded base (2) arranged in a plane perpendicular to the rotation shaft (1),
   at least one superconducting inductor coil (3), arranged covering the rounded base (2),
   a stationary housing enclosure (4), comprising the at least one superconducting inductor coil (3) and the rounded base (2), the stationary housing enclosure (4) being adapted to allow rotation of the rounded base (2) therein about the rotation shaft (1);
   a first cryogenic circuit (5) thermally connected with the at least one superconducting inductor coil (3) and said first cryogenic circuit (5) being adapted to cool the at least one superconducting inductor coil (3),
   a compressor connected to the first cryogenic circuit (5), the compressor being adapted to feed the first cryogenic circuit (5), and
a fixed stator assembly (103) comprising a current output, housing therein the inductor assembly (101) and an induced assembly (102), wherein the induced assembly (102) comprises:
   at least one induced coil (6),
   covering means (7) covering the at least one induced coil (6),
   a yoke (8) covering the covering means (7), and
   thermal insulating means (9) covering the yoke (8); and
   wherein the induced assembly is connected to the current output;
wherein:
   the stationary housing enclosure (4) comprises a first vacuum atmosphere generated by means of a vacuum circuit (10), where said vacuum circuit (10) is connected to a vacuum pump;
   the at least one superconducting inductor coil (3) comprises a plurality of layers of high-temperature superconducting material arranged in the rounded base (2); and
   the first cryogenic circuit (5) is housed in the rounded base (2), in thermal contact with the at least one superconducting inductor coil (3).

Clause 2. Electric generator (100) according to the preceding Clause 1, wherein the covering means (7) comprise frames (7.1) covering the at least one induced coil (6).

Clause 3. Electric generator (100) according to Clause 1, wherein:
the at least one induced coil (6) of the induced assembly is a superconducting induced coil and comprises a plurality of layers of high-temperature superconducting material;
the covering means (7) comprise a second cryogenic circuit adapted to cool the at least one induced coil (6).

Clause 4. Electric generator (100) according to any of the preceding Clauses, wherein the covering means (7) further comprise at least one one-way magnetic filter.

Clause 5. Electric generator (100) according to any of the preceding Clauses, wherein the inductor assembly of the electric generator (100) also comprises a rotation guide (11) for the base (2), where the rotation guide (11) is adapted to rotate the base (2) about the rotation shaft (1).

Clause 6. Electric generator (100) according to any of the preceding Clauses, wherein the first vacuum atmosphere of the stationary housing enclosure (4) is a low-vacuum, medium-vacuum, and/or ultra-vacuum atmosphere.

Clause 7. Electric generator (100) according to any of the preceding Clauses, wherein the compressor is adapted to feed the first cryogenic circuit (5) through a rotary valve (12).

Clause 8. Electric generator (100) according to any of the preceding Clauses, wherein the first cryogenic circuit (5) comprises a closed circuit connected to a McMahon compressor.

Clause 9. Electric generator (100) according to any of the preceding Clauses, wherein the first cryogenic circuit (5) comprises a low-density cryogenic gas.

Clause 10. Electric generator (100) according to the preceding Clauses, wherein the cryogenic gas of the first cryogenic circuit (5) is liquid nitrogen, helium, or a combination of both.

Clause 11. Electric generator (100) according to any of the preceding Clauses, wherein the thermal insulating means (9) comprise a second vacuum atmosphere (16).

Clause 12. Electric generator (100) according to the preceding Clauses, wherein the second vacuum atmosphere (16) of the thermal insulating means (9) is a high-vacuum and/or ultrahigh-vacuum atmosphere.

Clause 13. Electric generator (100) according to any of the preceding Clauses, wherein the high-temperature superconducting material of the at least one superconducting inductor coil (3) and/or the at least one induced coil (6) comprises at least one of the following materials: YBCO or La_{1.85}Ba_{0.15}CuO₄.

Clause 14. Electric generator (100) according to any of the preceding Clauses, wherein the rounded base (2) comprises polytetrafluoroethylene and/or fluorinated ethylene propylene.

Clause 15. Drive system comprising an electric generator (100) according to any of the preceding Clauses.

1. An electric generator, the electric generator comprising a rotation shaft adapted to rotate and a stationary housing enclosure; the stationary housing enclosure in turn comprising:
an inductor assembly, adapted to rotate together with the rotation shaft, comprising:
a rounded base arranged in a plane perpendicular to the rotation shaft,
at least one superconducting inductor coil, arranged covering the rounded base, wherein the stationary housing enclosure is adapted to allow rotation of the rounded base therein together with the rotation shaft;
a first cryogenic circuit thermally connected with the at least one superconducting inductor coil and said first cryogenic circuit being adapted to cool the at least one superconducting inductor coil, a compressor connected to the first cryogenic circuit, the compressor being adapted to feed the first cryogenic circuit, and
an induced assembly which comprises:
at least one induced coil,
covering means covering the at least one induced coil,
a yoke covering the covering means, and
thermal insulating means covering the yoke; and
wherein the induced assembly is connected to a current output;
wherein:
the stationary housing enclosure comprises a first vacuum atmosphere generated by means of a vacuum circuit, where said vacuum circuit is connected to a vacuum pump;
the at least one superconducting inductor coil comprises a plurality of layers of high-temperature superconducting material arranged in the rounded base; and
the first cryogenic circuit is housed in the rounded base, in thermal contact with the at least one superconducting inductor coil;
and wherein the first vacuum atmosphere of the stationary housing enclosure is one of the following atmospheres: a low-vacuum, i.e. in the pressure range of 1 to 300 mbar, and with a molecule density of between 10¹⁶ and 10¹⁹ molecules/cm³; medium-vacuum, i.e. in the pressure range of 10⁻³ to 1 mbar, and with a molecule density of between 10¹³ and 10¹⁶ molecules/cm³; or high vacuum, i.e., in the pressure range of 10⁻⁷ to 10⁻³ mbar, and with a molecule density of between 10⁹ and 10¹³ molecules/cm³; and wherein the thermal insulating means comprise a second vacuum atmosphere, the second vacuum atmosphere of the thermal insulating means being one of the following atmospheres: a high-vacuum; or ultrahigh-vacuum, i.e. in the pressure range of 10⁻¹² to 10⁻⁷ mbar, and with a molecule density of between 10⁴ and 10⁹ molecules/cm³; and
wherein the second vacuum atmosphere is enclosed between two walls of the stationary housing enclosure.

2. The electric generator according to claim 1, wherein the covering means comprise frames covering the at least one induced coil.

3. The electric generator according to claim 1, wherein:
the at least one induced coil of the induced assembly is a superconducting induced coil and comprises a plurality of layers of high-temperature superconducting material;
the covering means comprise a second cryogenic circuit adapted to cool the at least one induced coil.

4. The electric generator according to claim 1, wherein the covering means further comprises at least one one-way magnetic filter.

5. The electric generator according to claim 4, wherein the one-way magnetic filter comprises a permeable face in contact with the induced assembly of the electric generator and an impermeable face; wherein the permeable face is manufactured with a topological insulating material and the impermeable face is manufactured with a nickel and cobalt alloy.

6. The electric generator according to claim 5, wherein the topological insulating material comprise bismuth and/or tellurium.

7. The electric generator according to claim 1, wherein the inductor assembly of the electric generator further comprises a first bearing for the base, where the first bearing is adapted to rotate the base about the rotation shaft.

8. The electric generator according to claim 1, wherein the compressor is adapted to feed the first cryogenic circuit through a rotary valve.

9. The electric generator according to claim 1, wherein the first cryogenic circuit comprises a closed circuit connected to a McMahon compressor.

10. The electric generator according to claim 1, wherein the first cryogenic circuit comprises a low-density cryogenic gas.

11. The electric generator according to claim 10, wherein the cryogenic gas of the first cryogenic circuit is liquid nitrogen, helium, or a combination of both.

12. The electric generator according to claim 1, wherein the high-temperature superconducting material of the at least one superconducting inductor coil comprises at least one of the following materials: YBCO or La_{1.85}Ba_{0.15}CuO₄.

13. The electric generator according to claim 1, wherein the rounded base comprises polytetrafluoroethylene and/or fluorinated ethylene propylene.

14. The electric generator according to claim 1, wherein at least the layers of superconducting material of the inductor coils are arranged by means of a ceramic deposition using an inkjet technique.

15. The electric generator according to claim 1, wherein the stationary housing enclosure and the rotation shaft are attached by means of at least one magnetic seal.

16. A drive system comprising an electric generator according to claim 1.

17. The electric generator according to claim 4, wherein the one-way magnetic filter is adapted to allow the passage of magnetism in a single direction, resisting against the passage of said magnetism in the opposite direction.

18. The electric generator according to claim 3, wherein the high-temperature superconducting material of the at least one induced coil comprises at least one of the following materials: YBCO or La_{1.85}Ba_{0.15}CuO₄.

19. The electric generator according to claim 3, wherein the layers of superconducting material of the induced coils are arranged by means of a ceramic deposition using an inkjet technique.

20. The electric generator according to claim 19, wherein the layers of superconducting material of the inductor coils are arranged by means of a ceramic deposition using an inkjet technique.
